(19) United States
(12) Patent Application Publication
(10) Pub. No.: US 2011/0162357 A1
(43) Pub. Date: Jul. 7, 2011

(54) ENERGY CONVERTER

(76) Inventors: Norman West Bellamy, Coventry (GB); Neil Michael Bellamy, Nottingham (GB); Robert Ian Smith, Coventry (GB)

(21) Appl. No.: 12/994,685

(22) PCT Filed: May 29, 2009
(86) PCT No.: PCT/GB2009/001352

§ 371 Date: Mar. 22, 2011

(30) Foreign Application Priority Data
May 29, 2008 (GB) 0809732.1
Sep. 5, 2008 (GB) 0816172.1

(51) Int. Cl. F03B 13/18

(52) U.S. Cl. 60/505

(57) ABSTRACT

A wave energy converter for extracting energy from waves in a body of liquid. The converter comprising an endless spine, the spine including a plurality of spine sections (10). Each of the spine sections (10) houses at least one pneumatic absorber and each pneumatic absorber includes an oscillator that is displaceable cyclically on contact with an incident wave to pump air contained within the pneumatic absorber and thereby extract energy from the wave in the form of pneumatic energy. The spine further includes at least one high pressure duct (31) to direct air pumped from each of the pneumatic absorbers and thereby aggregate and rectify the pneumatic energy extracted via the pneumatic absorbers.

The invention relates to apparatus for extracting energy from waves in a body of liquid.

The movement of air caused when wind blows over an extensive stretch of water, such as an ocean, sea, lake, river or canal, generates waves on the surface of the water as the moving air displaces the water and thereby transmits energy to the water.

The energy stored in ocean and sea waves is considerable, the power of waves off the Atlantic coast of the UK typically measuring 70 kW per metre in deep water and dissipating to 20 kW per metre at the shoreline. Storm conditions generate waves having megawatts of power per metre that are destructive in nature, particularly in shoreline surf zones.

Since wind derives from solar energy, sea waves are considered a renewable energy source and the effects of climate change and the depletion of fossil fuels means that it is becoming increasingly desirable to harness the energy stored in sea waves.

The nature of sea waves however presents enormous engineering challenges, and there have been numerous attempts to devise an economical solution to harvest the power available from these waves.

A problem is that sea waves are generally random in height, period and direction. On a wave to wave basis, instantaneous power levels vary by the square of the wave height. Consequently the wave power profile varies from zero to random peaks every half wave cycle. This rapid variability of power level provides a challenge, particularly in terms of power conversion in a single unit.

One solution to handle this extreme dynamic power range is to aggregate energy from multiple phased units prior to conversion of the energy to mechanical energy. Another solution involves smoothing the fluctuations in power through the use of some form of energy storage. The storage capacity required is relatively modest bearing in mind that over a period of time the characteristics of sea waves remain constant, thereby defining a steady sea state.

The designs of wave energy converters typically fall into six groups: point absorbers, attenuators, terminators, overtopping reservoirs and submerged seabed devices.

Onboard power conversion to electricity is usually mechanical, hydraulic or pneumatic in nature and, if large scale energy at acceptable cost is required, then offshore floating terminators with pneumatic power conversion are generally considered to offer the most flexible of solutions. This is because terminator devices may be deployed freely in groups in the open sea where the density of wave energy is high and it is possible to maximize capture length.

Long terminator structures use their wave bridging ability as a stable frame of reference for wave absorbing mechanisms. Prior art structures known as spines, which are aligned in use along wave fronts, have proven practical for many types of wave energy converters including that disclosed in UK patent no. 2 075 127. These devices effectively terminate waves by absorbing their energy through the use of pneumatic or mechanical means.

However straight rigid spines must resist wave induced structural forces. This limits the practical length of individual spine devices and means that long spines, required for stability and high power output, are expensive to build. In addition, the movement of straight spines resulting from wave forces substantially reduces the efficiency of such wave energy converters. More stable platforms that can be produced at a lower cost therefore provide an economic advantage.

A more stable wave energy structure than the straight spine is a circular spine such as that disclosed in UK patent no. 2 161 864, which includes a plurality of individual wave absorbing sections connected end to end to form a ring.

The circular spine has been found to provide an effective frame of reference that maximizes energy capture efficiency and minimizes structural mass with respect to device size. In particular, the use of a torus structure means that the device behaves as both a terminator and an attenuator and extracts energy across the wave front and progressively as the wave passes through the device.

The stability of the ring structure also minimizes the surge, pitch and sway motion of the individual wave absorbing sections and removes any restriction on the location of the centre of gravity or buoyancy of the individual sections.

UK patent no. 2 161 864 discloses a circular spine device that is described as a simple device and uses the displacement of air to extract energy from sea waves. Typically twelve air chambers having outer faces formed from flexible rubber membranes are placed around a floating ring structure. Differential wave action moves the membrane air bag in and out forcing air to be exchanged between chambers. Self rectifying air turbines placed in the manifolds between the air chambers extract power from the air flow and drive electrical generators. The rigid torus structure, typically 60 m diameter or more, acts as a stable reference body and, in use, is moored a few kilometers offshore. Typically a 25 MW scheme deployed off the west coast of Scotland would feature 10 floating units and produce over 50 GWh per year of electricity.

When the device is in its inactive, closed-down mode the membrane air bags lie protected in their chambers and the freeboard of the structure reduces to a minimum, allowing storm waves to overtop and thereby avoid severe, slamming wave forces. This close-down mode also permits access to the device for maintenance purposes during calm conditions. To activate the device the closed circuit air system is pressurized to inflate the air bags to a mean displacement to allow the air bags to interchange air through the self-rectifying air turbines to deliver power in response to interacting phased random waves.

The structure is designed to receive wave energy from all directions and at different phases of the wave motion. The output of each of the twelve turbo-generators is aggregated to provide the total electrical output from the apparatus. This aggregation of different phased outputs provides some smoothing of the total power output.

Features such as omni-directional phased energy capture, high efficiency wave absorbers and a structurally efficient stable spine contribute towards high productivity and low energy cost.

Circular spine structures may be built economically with diameters of 60 m to 80 m, and thereby take advantage of the half wavelength resonance of swell waves. Structures of this size can therefore interact with large amounts of wave energy and, when sited off the west coast of the British Isles, produce annual average powers of 1 MW per device. Wave farms connected to the electrical grid onshore can therefore produce significant amounts of renewable energy and contribute to reducing dependence on fossil fuels.

The circular spine structure may be constructed from steel, concrete or any other suitable material. Steel structures based on ship design and build in shipyards are economic, quick to build and light weight. A typical steel ring spine structure may weigh around 1000 tonnes but requires up to 4000 tonnes of water ballast to achieve floating operational depth levels, which uses up to 80% of the structural space. Consequently while the inherent stability of the floating ring structure gives the freedom to design the internal space of the individual wave absorbing sections without the normal restrictions on centre of gravity and buoyancy, the space required to accommodate the water ballast renders it difficult to optimize the structural dimensions and utilize the space in the individual wave absorbing sections more effectively in order to improve performance of the wave energy converter.

In addition, while the use of self-rectifying turbines is attractive in that they are simple and produce uni-directional shaft power from reversing air flow without the use of rectifying valves, the efficiency band of current turbine designs is very narrow in comparison with the instantaneous air power input produced by wave action. At low power the turbine efficiency is low due to losses and at high power the turbine tends to stall with a rapid fall off in efficiency. While various design modifications have been tried, including variable pitch turbine blades, after 30 years of development overall turbine efficiency in real sea waves has remained low.

According to an aspect of the invention there is provided a wave energy converter for extracting energy from waves in a body of liquid, the converter comprising an endless spine, said spine including a plurality of spine sections, each of said spine sections housing at least one pneumatic absorber and each pneumatic absorber including an oscillator that is displaceable cyclically on contact with an incident wave to pump air contained within the pneumatic absorber and thereby extract energy from the wave in the form of pneumatic energy, characterized in that the spine further includes at least one high pressure duct to direct air pumped from each of the pneumatic absorbers and thereby aggregate and rectify the pneumatic energy extracted via the pneumatic absorbers.

The provision of at least one high pressure duct to direct air pumped from each of the pneumatic absorbers allows the pneumatic energy to be aggregated, or otherwise collected, and rectified, or otherwise directed in a single direction, so that the pneumatic energy may then be harnessed or converted into another form of energy in an efficient manner.

Each spine section preferably houses at least one pneumatic absorber including an oscillator in the form of an oscillating water column.

The use of an oscillating water column enables the wave energy converter to absorb and extract energy in the heave direction from swell waves which are incident, in use, on the end of the oscillating water column.

The use of an oscillating water column is also advantageous in that it does not include any moving parts.

In other embodiments of the invention each spine section may house a plurality of pneumatic absorbers including oscillators in the form of oscillating water columns, the oscillating water columns differing in length and/or cross-sectional area from one another.

Varying the length and or cross-sectional area of an oscillating water column alters the resonant frequency of the oscillating water column, it therefore allows the oscillating water column to be tuned to absorb energy from one or more specific frequencies of wave. The inclusion of a plurality of oscillating water columns, where each of the oscillating water columns differs in length and or cross-sectional area from one another therefore allows wave energy over a wide bandwidth to be absorbed efficiently.

Preferably in such embodiments the or at least one oscillating water column is bent. This means that when the wave energy converter in placed in a liquid, the end of the oscillating water column on which waves are incident, referred to herein as the excitation end of the oscillating water column, is directed toward and therefore absorbs wave energy in the surge direction of the waves. It also means that the excitation end of the oscillating water column is located closer toward the surface of the body of liquid, where the wave energy is greatest, than a straight oscillating water column of the same length.

In order to further increase the length of an oscillating water column whilst seeking, in use, to locate the excitation end of the oscillating water column as close to the surface of a body of liquid as possible, the oscillating water column may be U-shaped or N-shaped.

As an alternative or in addition to one or more pneumatic absorbers including oscillators in the form of oscillating water columns, each spine section may house at least one pneumatic absorber including an oscillator in the form of a flexible membrane.

The combination, in each spine section of both a flexible membrane and one or more straight oscillating water columns results in a device that is capable of absorbing and extracting energy from waves in both the heave and surge directions.

The combination of both a flexible membrane and one or more bent oscillating water columns also results in a device that is capable of absorbing and extracting wave energy over a wide bandwidth. This is because a flexible membrane, typically provided on an outer surface of a spine section, may be formed from a material of relatively low stiffness that is efficient at absorbing energy from the higher frequency wind generated waves which the or each oscillating water column may be tuned to absorb more powerful, low frequency swell waves.

Preferably each spine section includes a valve chamber in communication with the or each pneumatic absorber, the valve chamber including input and output non-return valves that are operable to allow air to be pumped out of the valve chamber via the output non-return valve, towards the high pressure duct, when the pressure of the air contained within the valve chamber is greater than the air pressure on the opposite side of the output non-return valve and air to be drawn into the valve chamber via the input non-return valve when the pressure of the air contained within the valve chamber is less than the air pressure on the opposite side of the input non-return valve.

The use of a valve chamber and input and output non-return valve serves to regulate the flow of air through each of the pneumatic absorbers, and to thereby assist in the rectification of the pneumatic energy extracted via the pneumatic absorbers.

Preferably the input non-return valve of each spine section communicates with a low pressure duct and the low pressure duct is connected to the high pressure duct to define a uni-directional air-flow pathway around the spine.

In such embodiments, the spine may further include at least two air storage reservoirs under differential pressure from an internal water head, the air storage reservoirs being connected to the high and low pressure ducts.

The provision of air storage reservoirs under differential pressure from an internal water head, connected to the high and low pressure ducts, is an effective means of balancing any differential in pressure between the high and low pressure ducts and acts to smooth fluctuations in the rate of air-flow around the spine.

This arrangement therefore can be used to make effective and efficient use of the ballast water, and the space it occupies, to store compressed air for the purpose of reducing fluctuations in air pressure and power.

Preferably a sloping division is provided between each of the air storage reservoirs so as to maximize the effective surface area of water within each of the air storage reservoirs. This is advantageous because increasing the effective surface area of water in each of the air storage reservoirs means that a small change in differential pressure in the tanks produces a much larger air smoothing capacity.

In other embodiments the low pressure duct may be omitted and the input non-return valve of each pneumatic absorber may communicate with air outside the spine section.

Preferably, in order to harness the pneumatic energy extracted via each of the pneumatic absorbers, the high pressure duct directs air pumped from the pneumatic absorbers through at least one air turbine that is coupled to an electrical generator to produce electrical power for transmission to land.

The spine preferably defines a substantially circular ring so that, in use, the pneumatic absorbers are able to absorb and extracts energy across the wave front and progressively as the wave passes the spine.

The use of a circular spine is particularly advantageous in embodiments where each spine section houses at least one pneumatic absorber including an oscillator in the form of an oscillating water column. This is because the circular spine provides a stable frame of reference within the body of liquid, which is of particular necessity in the use of oscillating water columns.

The spine sections preferably define discrete units connected end to end with at least one coupling module, which may house at least one air turbine coupled to an electrical generator in embodiments where the pneumatic energy is converter into electrical power.

Preferably the pneumatic absorbers are located and spaced about the periphery of the spine so that the wave energy converter is able to extract and absorb energy from waves incident from any direction.

In such embodiments, the resultant wave energy converter may be formed to be particularly stable in use. The sea keeping of each section, and the total ring structure, requires structural integrity and sufficient buoyancy to maintain floatation and damage stability. The device is too wide to capsize in any sea condition and will only be in danger of sinking when two or more sections are compromised. Normal floating structures that include the functional arrangements outlined above might otherwise require expensive stablilizing structures to account for issues relating to centre of gravity and buoyancy in order to avoid being subject to capsize.

According to another aspect of the invention, there is provided apparatus for extracting energy from waves in a body of liquid, comprising an endless spine as a frame of reference in water, said spine carrying a plurality of pneumatic absorbers adapted to be displaced cyclically by the waves so that by said cyclic displacement the energy of the waves can be extracted, characterized in that the pneumatic energy is rectified and aggregated before conversion to a more useable form of energy.

Preferably the spine defines a substantially circular ring, which may be made up of a plurality of ring sections connected end to end.

The pneumatic absorbers may be located and spaced around the periphery of the spine ring, and the rectified pneumatic power from each section is preferably distributed around the spine ring by high pressure and low pressure air ducts.

In such embodiments, the air ducts in some or all sections may be connected to air storage reservoirs within those sections which are under differential pressure from internal water head.

In embodiments of the invention the pneumatic absorber may comprise a flexible membrane located to the outside of the spine and located behind the membrane is an air cavity from which air is pumped through rectifying valves into the high pressure air duct and into which air is drawn through rectifying valves from the low pressure air duct as the membrane is flexed back and forth under the influence of waves.

In other embodiments the pneumatic absorbers may comprise oscillating water columns located within the spine and located above the water column is an air column from which air is pumped through rectifying valves into the high pressure air duct and into which air is drawn through rectifying valves from the low pressure air duct as the water column oscillates up and down under the influence of waves.

In yet further embodiments, the pneumatic absorbers comprise of a mix of flexible membrane absorbers and oscillating water columns.

Preferably the pneumatic absorbers in each section comprise a plurality of oscillating water columns.

The pneumatic absorbers may comprise oscillating water columns located within the spine and located above the water column is an air column from which air is pumped through rectifying valves into the high pressure air duct and into which air is drawn through rectifying valves from the atmosphere as the water column oscillates up and down under the influence of waves.

In such embodiments, the high pressure air duct may pressurize the air column to lower the surface of the water column to increase the buoyancy of the structure and hence store energy for smoothing the output power of the device.

Preferably a section of the spine is fitted with a conversion means to convert air flow from the high pressure duct to the low pressure duct into energy in a more readily useable form, and the conversion means may comprise an air turbine driving an electrical generator.

In each of the aspects of the invention, the self rectifying action of the turbo-generators may be replaced by rectifying the air flow from each pneumatic absorber using two or more, non-return valves feeding high and low pressure air ducts running around the spine.

This systems enables all of the pneumatic power from each absorber to be aggregated at an early stage of power conversion prior to driving more conventional types of turbine.

The phasing aspect of the aggregated air power considerably reduces the fluctuation in the delivered power to the mechanical, electrical and grid equipment, and provides an improved match to the high efficiency characteristic of certain types of turbine, such as Francis or Kaplan.

The equipment rating problem is also eased in that variations in mean air pressure can be accommodated, if required, by varying adjustable guide vanes, and variations in air flow can be accommodated by varying the number of turbo-generator units operating in parallel.

Embodiments of the invention will now be described, by way of non-limiting examples, with reference to the accompanying drawings in which:

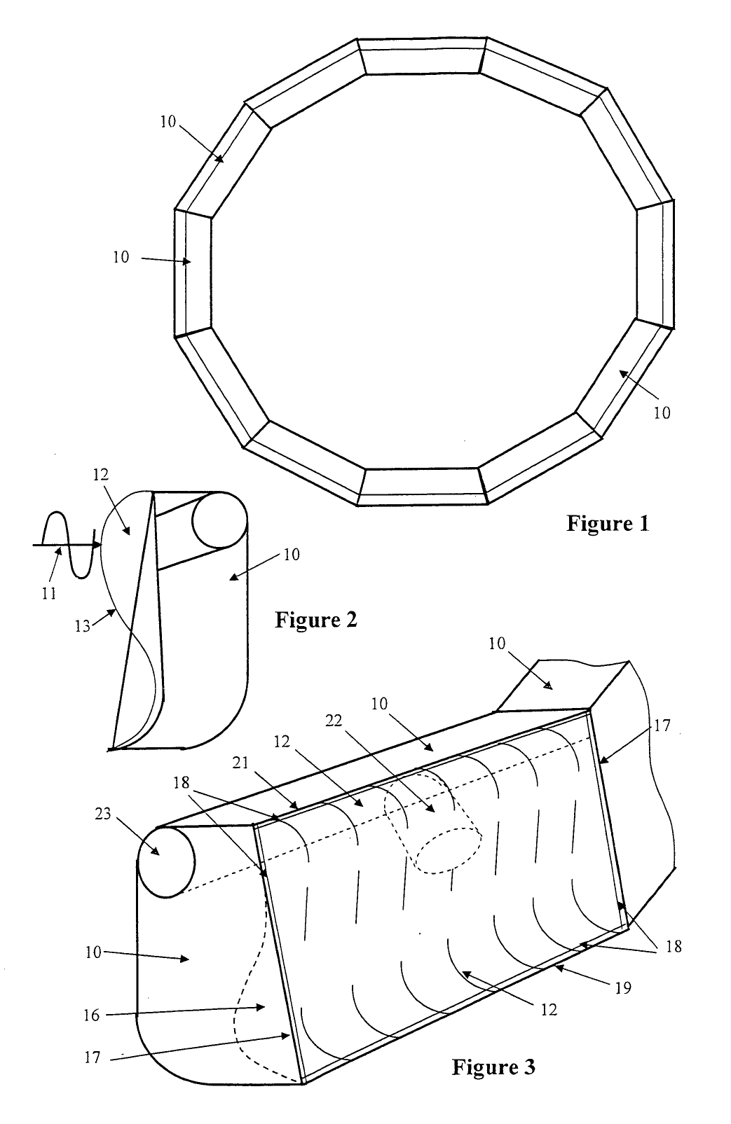

FIG. 1 is a plan view of the circular clam wave energy converter disclosed in UK patent no. 2 161 864;

FIG. 2 is a sectional elevational side view of the wave energy converter shown in FIG. 1;

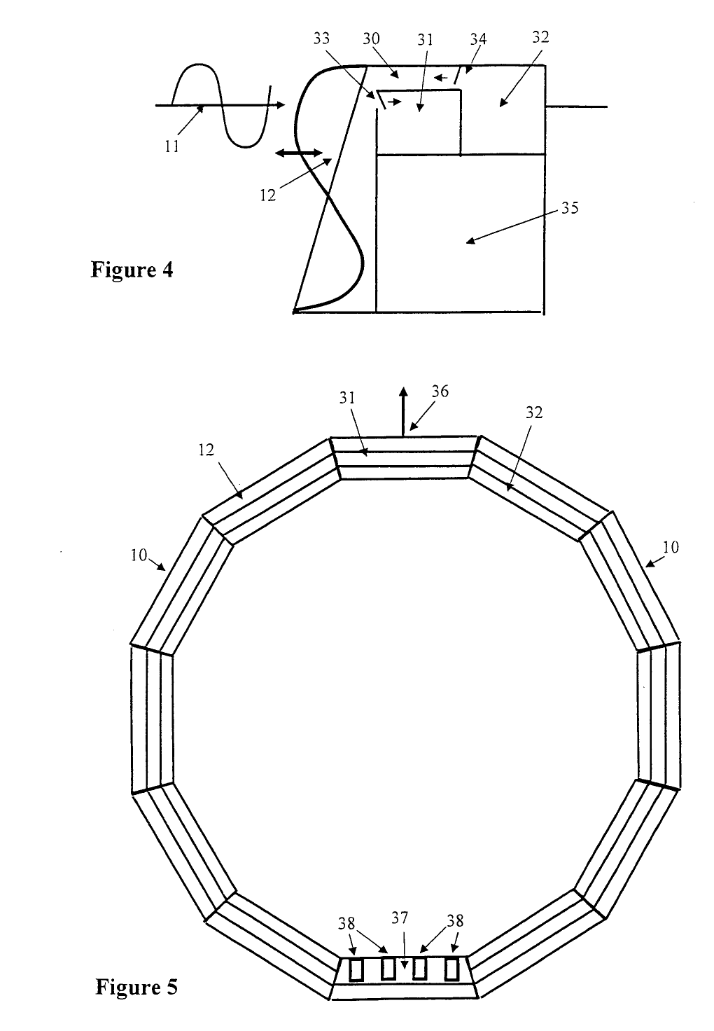

FIG. 3 is a perspective elevational view of the wave energy converter shown in FIG. 1;

FIG. 4 is a sectional elevational side view of an embodiment of the invention showing an arrangement of non-return valves feeding high and low pressure ducts;

FIG. 5 is a plan view showing high and low pressure ducts providing two ring mains around the ring structure feeding a power module;

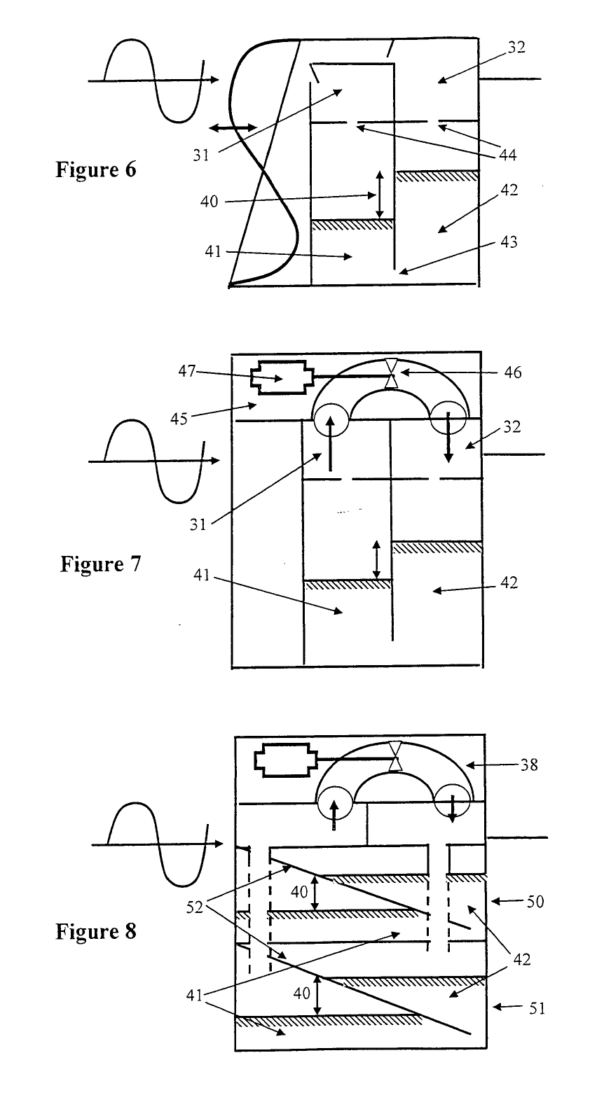

FIG. 6 is a sectional elevational side view of an embodiment of the invention showing the arrangement of non-return valves feeding high and low pressure ducts connecter to air storage reservoirs;

FIG. 7 is a sectional elevational side view of the embodiment shown in FIG. 6, omitting any pneumatic absorbers, showing the high and low pressure ducts connected to the power module and to air storage reservoirs;

FIG. 8 is a sectional elevational side view of another embodiment of the invention, omitting any pneumatic absorbers, showing the high and low pressure ducts connected to the power module and to air storage reservoirs;

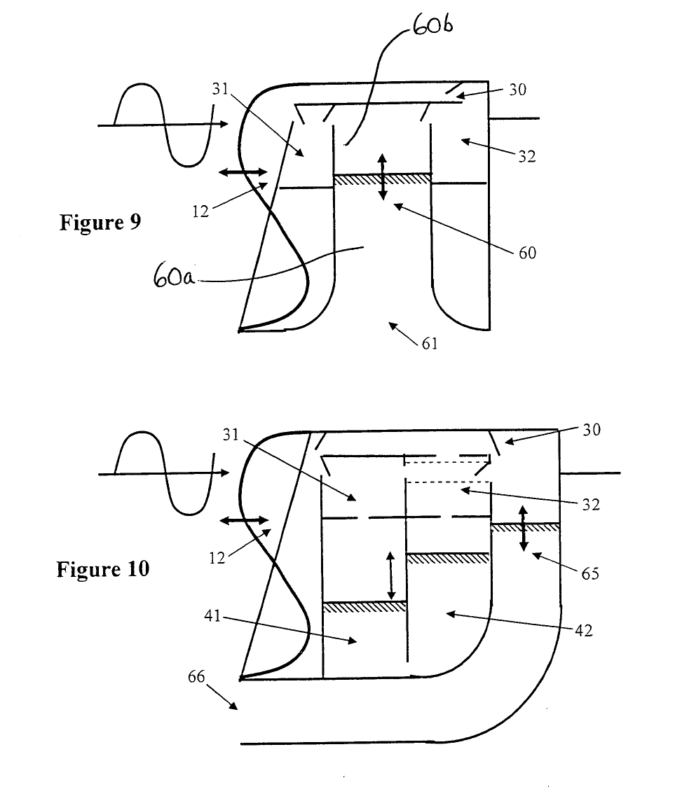

FIG. 9 is a sectional elevational side view of an embodiment of the invention similar to that shown in FIG. 4 showing an additional oscillating water column;

FIG. 10 is a sectional elevational side view of an embodiment of the invention similar to that shown in FIG. 4 showing an additional oscillating water column and an air storage reservoir;

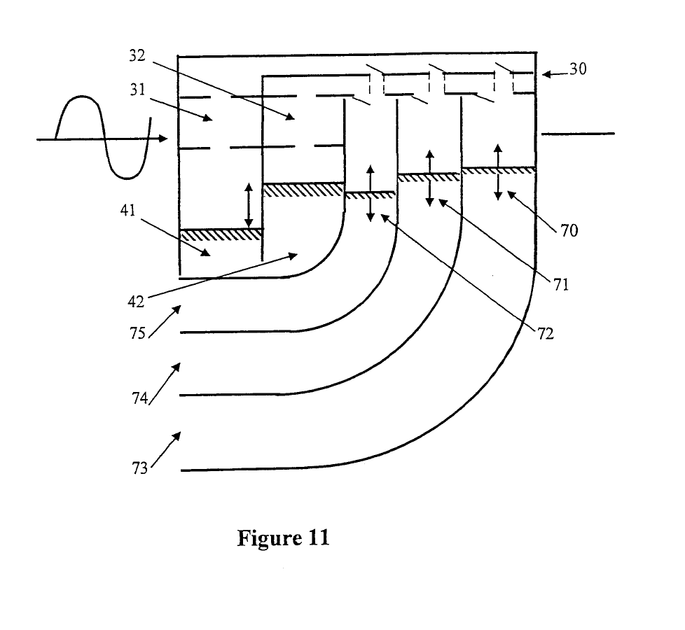

FIG. 11 is a sectional elevational side view of an embodiment of the invention similar to that shown in FIG. 10 showing three oscillating water columns without an air bag absorber;

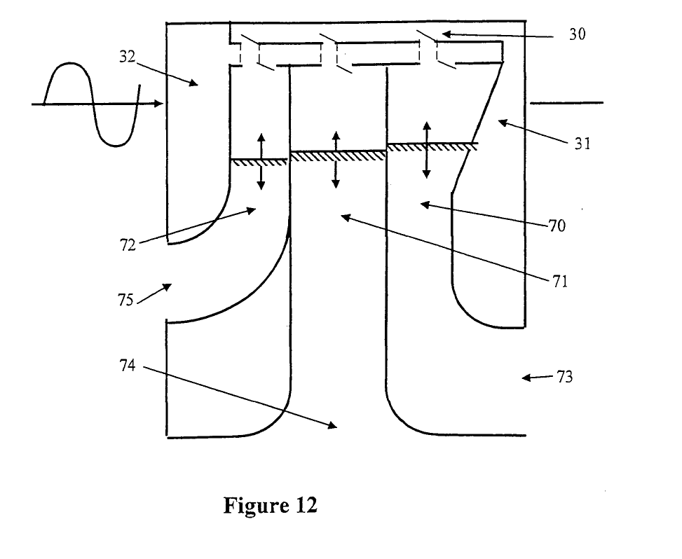

FIG. 12 is a sectional elevational side view of an embodiment of the invention similar to that shown in FIG. 11 showing a different arrangement of three oscillating water columns;

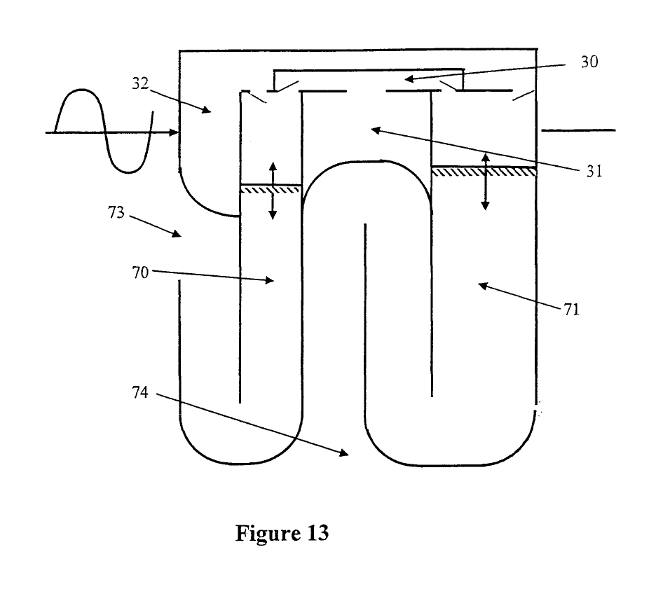

FIG. 13 is a sectional elevational side view of an embodiment of the invention similar to that shown in FIG. 11 showing an arrangement of two oscillating water columns; and

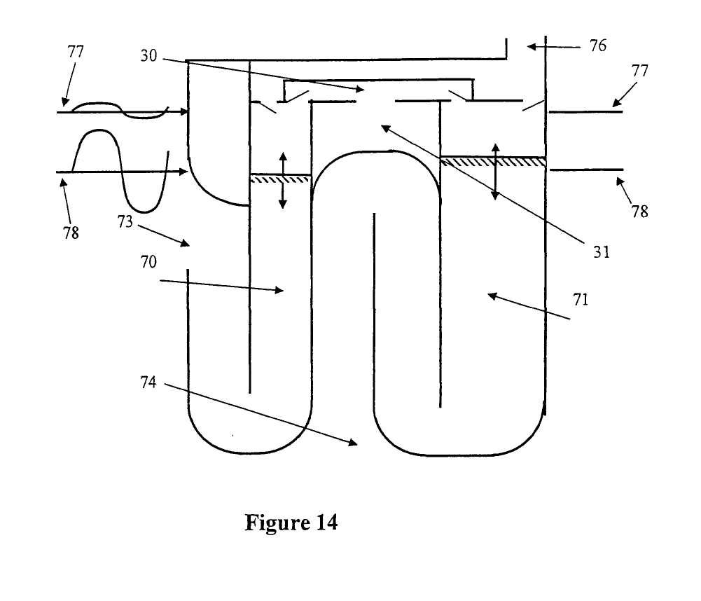

FIG. 14 is a sectional elevational side view of an embodiment of the invention similar to that shown in FIG. 13 showing a different arrangement of air ducting and air storage.

FIG. 1 shows a ring spine forming part of an apparatus for extracting and converting the energy of waves in a body of liquid, typically the sea or ocean. The ring spine includes a number of sections 10 connected end to end.

While the sections 10 are connected essentially to define a circular spine, it is not necessary for the spine to be circular. It must however be endless or otherwise continuous.

The apparatus may be designed for floating on a surface of a body of water, or it may be designed for anchorage, for example, on the sea bed. In all cases however it must come under the influence of waves in order to be functional.

The typical mean level of water 11 relative to the apparatus, in use, is shown in FIG. 2.

Each of the sections 10 forms a pneumatic absorber and includes an outer surface formed from a flexible membrane bag 12 having a typical S-shaped profile 13. The bag 12 forms a drive member or oscillator for extracting energy from incident waves.

The bag 12 contains air or another fluid under pressure and, by virtue of the action of an incident wave, is subjected in use cyclically to compressive forces whereby it acts as a pump. In each cycle, when the incident wave subsides, the bag 12 is free to expand and draw in air or fluid.

This expansion and contraction of the bag 12 of each section 10 is utilized for energy conservation in that the displacement of fluid by the expansion and contraction is used to drive a prime mover in the form of a turbo-generator.

A rectangular buoyant spine section 10 is shown in FIG. 3, which forms part of the ring spine shown in FIG. 1.

The front face of the section 10 is depressed to form a cavity 16 between the end buttresses 17 to create an inclined frame 18 designed to support the edges 19 of the flexible membrane bag 12. The edges of the flexible membrane bag 12 are bonded and held to the edge faces of the buttresses 17 and the top and bottom edges 21,19 of the spine so that an airtight cavity 16 is formed between the flexible membrane bag 12, the buttresses 17 and the spine.

The geometric shape and stretch characteristics of the flexible membrane bag 12 allows it to form an S-shaped vertical profile 13 when under operating pressure and immersed in water. Each cavity 16 is pneumatically connected via a short duct 22 to a ring main duct 23 that runs around the spine in order to form a closed circuit pressurized air system.

Power is extracted from the air flow by a self-rectifying turbine coupled to an electrical generator and located in either the short duct 22 connected between the cavity 16 and the ring main duct 23, so as to create a parallel air system arrangement, or in the ring main duct 23 connecting to the neighbouring section 10, so as to create a series air system. In each case the electrical power outputs from the turbo-generator of each section 10 are aggregated, or otherwise collected, to provide the total output of the apparatus.

A wave energy converter according to an embodiment of the invention is shown in FIGS. 4 and 5.

The wave energy converter includes a plurality of the spine sections 10 and a power module 37 connected end to end to form an endless spine, each spine section 10 including a ballast section 35 to receive ballast, preferably in the form of water.

In the embodiment shown in FIG. 5, the spine sections 10 and the power module 37 are connected to define a circular ring. In other embodiments it is envisaged that the spine sections 10 and the power module 37 may be connected to define an endless spine of another shape, such as a triangular, square or rectangular spine.

Each spine section 10 houses a pneumatic absorber including an oscillator in the form of a flexible membrane 12 that is displaceable cyclically on contact with an incident wave to pump air contained within the pneumatic absorber and thereby extract energy from the wave in the form of pneumatic energy.

The spine includes a high pressure duct 31 to direct air pumped from each of the pneumatic absorbers and thereby aggregate and rectify the pneumatic energy extracted via the pneumatic absorbers.

Each pneumatic absorber communicates with a valve chamber 30 having an input non-return valve 34 and an output non-return valve 33 to ensure a rectified flow of air.

On cyclic displacement of the bag 12, air is pumped into the valve chamber 30 and the input and output non-return valves 34,33 are operable to allow air air to be pumped out of the valve chamber 30 via the output non-return valve 33, towards the high pressure duct 31, when the pressure of the air contained within the valve chamber 30 is greater than the air pressure on the opposite side of the output non-return valve 33.

The input and output non-return valves 34,33 are also operable to allow air to be drawn into the valve chamber 30 via the input non-return valve 33 when the pressure of air contained within the valve chamber 30 is less than the air pressure on the opposite side of the input non-return valve 33.

Consequently displacement of the bag 12 on contact with an incident wave results in the pumping of air into the high pressure duct via the valve chamber 30 and the output non-return valve 33. Displacement of the bag 12 when the wave subsides results in air being drawn into the pneumatic absorber, via the input non-return valve 34 and the valve chamber 30 to replace the air that has been pumped into the high pressure duct 31, and thereby results in a rectified flow of air through the pneumatic absorber and into the high pressure duct 31.

The wave energy converter shown in FIGS. 4 and 5 also includes a low pressure duct 32, which communicates with the input non-return valve of each of the pneumatic absorbers 10.

In order to convert the pneumatic energy extracted from incident waves via the pneumatic absorbers in the form of pressurized air, the wave energy converter includes a power module 37 to convert the pneumatic energy into a more useful form of energy. The power module 37 includes turbo-generators located in plant housings 38 on top of the power module 37, and the high pressure duct 31 directs air pumped from each of the pneumatic absorbers 10 through the turbo-generators.

The low pressure duct 32 is connected to the high pressure duct 31 via the turbo-generators 38, and together with the input and output non-return valves 34,33 of each pneumatic absorber, defines a uni-directional air-flow pathway around the spine.

A pneumatic absorber 10 according to another embodiment is shown in FIG. 6.

The pneumatic absorber 10 shown in FIG. 6 differs from the pneumatic absorber 10 shown in FIG. 4 in that it omits ballast section 35 to contain ballast water, and instead includes ballast water in air storage tanks 41,42.

In the pneumatic absorber 10 shown in FIG. 6 the high and low pressure ducts 31,32 are connected via orifices 44 to air storage reservoirs that are under differential pressure, indicated by reference numeral 40, from an internal water head.

The air storage reservoirs define a high pressure air storage tank 41 and a low pressure air storage tank 42, which are connected at or towards their bottom 43 to permit the free movement of water between the tanks that is brought about by changes in differential pressure 40 in the air storage tanks 41,42 and the connected high and low pressure ducts 31,32.

Each of the air storage tanks 41,42 is part filled with water, are connected at their top to a respective one of the high and low pressure ducts 31,32 and connected at their bottom 43 to allow water passage between the air storage tanks 41,42. This allows the water levels in the air storage tanks 41,42 to adjust to the air pressure difference in the high and low pressure ducts 31,32.

If the differential pressure in the high and low pressure ducts 31,32 increases, due to increased wave activity and therefore an increased amount of pneumatic energy extracted via the pneumatic absorbers, then water will be pumped from the high pressure air storage tank 41 and cause air to flow into the high pressure air storage tank 41 from the low pressure air storage tank 42, effectively storing energy.

Conversely, if the differential pressure decreases due to a decrease in wave activity, then water will be pumped in the opposite direction and cause air to flow into the high pressure duct 31 connected to the high pressure air storage tank 41 and out of the low pressure duct 32 into the low pressure storage tank 42, effectively feeding stored energy into the system, as shown in FIG. 7.

The connected air storage tanks 41,42 therefore reduce the effects of any fluctuation of differential air pressure and ensures that the air-flow through the turbine 46 from the high pressure duct 31 to the low pressure duct 32 is uni-directional to produce electrical power for transmission to land.

This process reduces the effects of fluctuations in changes in wave activity on the flow of pneumatic energy, via the high pressure duct 31, to the turbine 46 and thereby has a smoothing effect on the electrical power delivered from the power module 37.

Within limits, the effective storage capacity is proportional to the surface area of the air storage tanks 41,42. This however only applies over the range of operational differential pressures, which is much less than the depth of the air-storage tanks 41,42 illustrated in FIG. 6. This means that a larger proportion of the water in the tanks is not utilized in the air storage process.

As outlined above, the effective storage capacity of the air storage tanks 41,42 is maximized when the tank area is maximized. Multiple tanks with sloping divisions have higher capacities and can utilize ballast more effectively, and one such embodiment of the invention is shown in FIG. 8.

The air storage tanks 41,42 shown in FIG. 8 are similar to those shown in FIG. 7 but provide a more effective air storage arrangement.

The storage arrangement includes two or more levels 50,51 of storage tank, both with a sloping division 52 between the high pressure air storage tank 41 and the low pressure air storage tank 42, which increases the effective surface area of the water in the air storage tanks 41,42.

Since pressure is directly related to surface area, this means that small changes in the differential pressure 40 in the tanks produces a much larger air smoothing capacity than that of the embodiment shown in FIGS. 6 and 7, and utilizes more water in the air storage tanks 41,42 than indicated in the description relating to FIG. 6. It therefore makes an even more efficient use of the ballast water. In such an arrangement the potential storage capacity of the ballast water is sufficient to smooth the delivered power to the grid to acceptable standards and output power variations will generally be according to sea state and not individual wave motion.

A spine section 10 of a wave energy converter according to another embodiment of the invention is shown in FIG. 9.

The spine section 10 houses a pneumatic absorber including an oscillator in the form of a flexible membrane 12 and a pneumatic absorber including an oscillator in the form of a vertically aligned oscillating water column 60.

The oscillating water column 60 includes a water column 60a above which is located an air column 60b. The water column 60a is coupled to heave wave excitation at the excitation end 61 of the oscillating water column 60, thereby causing cyclic displacement of the water column 60a which in turn pumps the air contained in the air column 60b.

This arrangement enables the pneumatic absorbers of each spine section 10 to absorb wave energy from both surge and heave directions. The pneumatic absorber including an oscillator in the form of a flexible membrane 12 on an outer surface of the spine section 10 is efficient at absorbing energy from the higher frequency local wind generated waves whilst the pneumatic absorber including an oscillator in the form of an oscillating water column 60 is efficient at absorbing the more powerful low frequency swell waves.

The oscillating water column will also absorb some energy by helping to damp out the heave motion of the spine section 10 that arises from the pitch resonance of the half-wavelength circular substructure of the wave energy converter.

Both the flexible membrane 12 and the oscillating water column 60 pump air from their respective pneumatic absorbers into the valve chamber 30 and into the high pressure duct 31 in a similar manner to that outlined with reference to FIGS. 4 and 5. Similarly air flows from the low pressure duct 32 into the valve chamber 30 and into the respective pneumatic absorbers, as required, during the cyclic movement of the flexible membrane 12 and the oscillating water column 60.

In order to increase the amount of energy extracted using the wave energy converter, the structure of the oscillating water column may be modified so as to couple to the surge motion of the waves and one such embodiment is shown in FIG. 10.

In the embodiment shown in FIG. 10, the spine section 10 houses a pneumatic absorber including an oscillator in the form of a flexible membrane 12 and a pneumatic absorber including an oscillator in the form of an oscillating water column 65.

The oscillating water column 65 is bent to couple to wave motion in the surge direction at the excitation end 66. This allows the length of the oscillating water column to be maximized to enable it to tune into the energy of very low frequency swell waves.

The structural section of the spine section shown in FIG. 10 is larger than that of the spine sections shown in FIGS. 4 and 6 to 9 so as to accommodate both the oscillating water column 65 and air storage tanks 41,42, which function in the same manner as outlined with reference to FIG. 6.

Both the flexible membrane 12 and the oscillating water column 65 pump air from the respective pneumatic absorbers into the valve chamber 30 and into the high pressure duct 31 in a similar manner to that outlined with reference to FIGS. 4 and 5. Similarly air flows from the low pressure duct 32 into the valve chamber 30 and into the respective pneumatic absorbers, as required, during the cyclic movement of the flexible membrane 12 and the oscillating water column 65.

A spine section of a wave energy converter according to another embodiment is shown in FIG. 11.

In this embodiment the spine section houses three pneumatic absorber including oscillators in the form of oscillating water columns 70,71,73. Each of the oscillating water columns 70,71,72 is bent to couple to wave motion in the surge direction at its respective excitation end 73,74,75.

The oscillating water columns 70,71,72 vary in length from one another and are each tuned to a different frequency according to column length. Consequently the oscillating water columns 70,71,72 allow the pneumatic absorber to efficiently absorb energy over a wide bandwidth of wave energy.

The oscillating water columns 70,71,72 pump air from the respective pneumatic absorbers into the valve chamber 30 and into the high pressure duct 31 in a similar manner to that outlined with reference to FIGS. 4 and 5. Similarly air flows from the low pressure duct 32 into the valve chamber 30 and into the respective pneumatic absorbers, as required, during the cyclic movement of the oscillating water columns 70,71,72.

One particular advantage of this embodiment is that the number of moving parts is minimized. Moving parts are only included in the non-return valves and the turbo-generator equipment.

A spine section of a wave energy converter according to a further embodiment of the invention is shown in FIG. 12.

The spine section houses a pneumatic absorber including an oscillator in the form of a central, vertically aligned, oscillating water column 71 and two pneumatic absorber located to each side thereof including oscillators in the form of bent oscillating water columns 70,72.

The two bent oscillating water columns 70,72 are bent in opposite directions so as to couple to wave motion in opposite surge directions. In addition the bent oscillating water columns 70,72 differ in length from one another and are each tuned to a different frequency according to column length.

This arrangement allows the oscillating water columns 70,71,72 of the pneumatic absorbers to couple to wave motion in both the surge and heave directions at excitation ends 73,74,75.

The oscillating water columns 70,71,72 pump air from the respective pneumatic absorbers into the valve chamber 30 and into the high pressure duct 31 in a similar manner to that outlined with reference to FIGS. 4 and 5. Similarly air flows from the low pressure duct 32 into the valve chamber 30 and into the respective pneumatic absorber, as required, during the cyclic movement of the oscillating water columns 70,71,72.

Again the number of moving parts in this embodiment is minimized.

A spine section of a wave energy converter according to a yet further embodiment of the invention is shown in FIG. 13.

The spine section houses pneumatic absorbers including oscillators in the form of oscillating water columns 70,71 excited in the respective surge and heave directions at excitation ends 73,74.

One of the oscillating water columns 70 is U-shaped and the other 71 is N-shaped so as to increase the length of the resonant water column and hence energy periods.

Each of the oscillating water columns 70,71 is turned to a different frequency according to column length, and the twin arrangement can be designed to efficiently absorb energy over a wide bandwidth of wave energy.

The oscillating water columns 70 71 pump air from the respective pneumatic absorbers into the valve chamber 30 and into the high pressure duct 31 in a similar manner to that outlined with reference to FIGS. 4 and 5. Similarly air flows from the low pressure duct 32 into the valve chamber 20 and into the respective pneumatic absorbers, as required, during the cyclic movement of the oscillating water columns 70,71.

It is envisaged that in other embodiments of the invention each spine section 10 may house variations of the oscillating water column structures. Other structures include but are not limited to mixes of horizontal and vertically excited oscillating water columns that can be accommodated within the structural section of the spine section.

Each of the embodiments of wave energy converter described with reference to FIGS. 4 to 13 includes the provision of a low pressure duct 32. It is envisaged however that the low pressure duct 32 may be omitted and a spine section of one such embodiment of a wave energy converter is shown in FIG. 14.

The pneumatic absorbers housed in the spine section shown in FIG. 14 are essentially the same as the pneumatic absorbers of the spine section shown in FIG. 13 and includes oscillators in the form of oscillating water columns 70,71.

However, in place of the low pressure duct, the spine section includes an open duct 76 into the valve chamber 30.

In use, air is drawn into the respective pneumatic absorbers and into air columns located above the water columns 70,71, via the input non-return valves and the valve chamber 30, when the water columns fall.

When the water columns 70,71 rise, air is pumped from the respective pneumatic absorbers, via the valve chamber 30 and the output non-return valves, into the high pressure duct 31.

If waves are small in amplitude, the air pressure in the air columns and the high pressure duct 31 is low and the waterline outside the structure is relatively high, as demonstrated by waveform 77.

For larger wave amplitudes, the air pressure in the air columns and the high pressure duct is higher and the waterline outside the structure is lower, as demonstrated by waveform 78.

This increase in buoyancy and resultant increase in freeboard is due to the extra air stored in the structure caused by the air column pressure forcing down the mean water levels in the oscillating water columns 70 71.

This feature is useful in storing energy, which can be stored during increased wave activity and given up during lower wave activity, thereby smoothing a fluctuating power output and enabling larger column excursions in higher sea states.

1. A wave energy converter for extracting energy from waves in a body of liquid, the converter comprising an endless spine, said spine including a plurality of spine sections, each of said spine sections housing at least one pneumatic absorber and each pneumatic absorber including an oscillator that is displaceable cyclically on contact with an incident wave to pump air contained within the pneumatic absorber and thereby extract energy from the wave in the form of pneumatic energy, characterized in that the spine further includes at least one high pressure duct to direct air pumped from each of the pneumatic absorbers and thereby aggregate and rectify the pneumatic energy extracted via the pneumatic absorbers.

2. A wave energy converter according to claim 1 wherein each spine section houses at least one pneumatic absorber including an oscillator in the form of an oscillating water column.

3. A wave energy converter according to claim 2 wherein each spine section houses a plurality of pneumatic absorbers including oscillators in the form of oscillating water columns, the oscillating water columns differing in length from one another.

4. A wave energy converter according to claim 2 wherein each spine section houses a plurality of pneumatic absorbers including oscillators in the form of oscillating water columns, the oscillating water columns differing in cross-sectional area from one another.

5. A wave energy converter according to claim 2 wherein the or at least one oscillating water column is bent.

6. A wave energy converter according to claim 5 wherein the or at least one oscillating water column is U-shaped.

7. A wave energy converter according to claim 5 wherein the or at least one oscillating water column is N-shaped.

8. A wave energy converter according to claim 1 wherein each spine section houses at least one pneumatic absorber including an oscillator in the form of a flexible membrane.

9. A wave energy converter according to claim 1 wherein each spine section includes a valve chamber in communication with the or each pneumatic absorber, the valve chamber including input and output non-return valves that are operable to allow air to be pumped out of the valve chamber via the output non-return valve, towards the high pressure duct, when the pressure of the air contained within the valve chamber is greater than the air pressure on the opposite side of the output non-return valve and air to be drawn into the valve chamber via the input non-return valve when the pressure of the air contained within the valve chamber is less than the air pressure on the opposite side of the input non-return valve.

10. A wave energy converter according to claim 9 wherein the input non-return valve of each spine section communicates with a low pressure duct and the low pressure duct is connected to the high pressure duct to define a uni-directional air-flow pathway around the spine.

11. A wave energy converter according to claim 10 wherein the spine further includes at least two air storage reservoirs under differential pressure from an internal water head, the air storage reservoirs being connected to the high and low pressure ducts.

12. A wave energy converter according to claim 11 wherein a sloping division is provided between the air storage reservoirs so as to maximize the effective surface area of water within each of the air storage reservoirs

13. A wave energy converter according to claim 9 wherein the input non-return valve of each spine section communicates with air outside the spine section.

14. A wave energy converter according to claim 1 wherein the high pressure duct directs air pumped from the pneumatic absorbers through at least one air turbine that is coupled to an electrical generator to produce electrical power for transmission to land.

15. A wave energy converter according to claim 1 wherein the spine defines a substantially circular ring.

16. A wave energy converter according to claim 1 wherein the spine sections define discrete units and the spine further includes at least one coupling module, the spine sections and the coupling module being connected end to end.

17. A wave energy converter according to claim 14 wherein the or each coupling module is a power module.

18. A wave energy converter according to claim 1 wherein the pneumatic absorbers are located and spaced about the periphery of the spine.

19.-32. (canceled)
